(19) United States
(12) Patent Application Publication
(10) Pub. No.: US 2022/0019459 A1
(43) Pub. Date: Jan. 20, 2022

(54) CONTROLLED EARLY RESPONSE IN MASTER-SLAVE SYSTEMS

(71) Applicant: QUALCOMM Incorporated, San Diego, CA (US)

(72) Inventor: Jean-Jacques LECLER, Antibes (FR)

(21) Appl. No.: 16/933,209

(22) Filed: Jul. 20, 2020

(51) Int. Cl. G06F 9/46; G06F 9/48; G06F 9/54; G06F 9/50; G06F 13/362

(52) U.S. Cl. CPC G06F 9/466; G06F 9/4881; G06F 13/362; G06F 9/5027; G06F 9/546

(57) ABSTRACT

Aspects of the present disclosure provide techniques for controlling early responses in systems employing master devices and slave devices. An example method for controlling a slave device includes receiving a plurality of transaction requests from a master device for the slave device to execute and respond, determining whether a response criterion is met based on a number of the plurality of transaction requests that have been executed and a number of response messages transmitted to the master device for the plurality of transaction requests, while the response criterion is met, proceeding with transmitting response messages for the plurality of transaction requests, and while the response criterion is not met, refraining from transmitting response messages for any of the plurality of transaction requests.

### TECHNICAL FIELD

The teachings of the present disclosure relate generally to systems employing master and slave devices, and more particularly, to controlled early responses in such systems.

### INTRODUCTION

Computing devices are ubiquitous. Some computing devices are portable such as mobile phones, tablets, and laptop computers. As the functionality of such portable computing devices increases, the computing or processing power required and generally the data storage capacity to support such functionality also increases. In addition to the primary function of these devices, many include elements that support peripheral functions. For example, a cellular telephone may include the primary function of enabling and supporting cellular telephone calls and the peripheral functions of a still camera, a video camera, global positioning system (GPS) navigation, web browsing, sending and receiving emails, sending and receiving text messages, push-to-talk capabilities, etc. Many of these portable devices include a SoC to enable one or more primary and peripheral functions on the specific device.

In mobile SoCs, chip performance is becoming increasingly important. A SoC integrated circuit (IC) is a system in which a group of circuits performing related functions are integrated onto, and fabricated upon, a single die/substrate or multiple dies/substrates. A SoC IC generally includes functional blocks of circuitry, such as, for example, microprocessors, digital signal processors, memory arrays, buffers, and so on. These functional blocks of circuitry are sometimes referred to as cores. The functional blocks are each electrically connected to an interconnect bus, within the SoC IC, over which the functional blocks exchange data with each other and any other devices connected to the bus.

In the SoC, functional blocks such as master devices communicate with functional blocks such as slave devices via the interconnect bus (e.g., a network-on-a-chip (NoC), interconnect, bus, etc.) that provides an intersubsystem data transfer path. An interconnect bus may include a number of sockets. A socket is an interface through which transactions may be exchanged, such as transactions described herein. In certain contexts in literature, master and slave refer to each side of a particular socket, where a socket of an interconnect bus receives transaction requests through slave interfaces and forwards them downstream through master interfaces. Accordingly, a transaction request may pass through multiple sockets, with multiple master and slave interfaces forwarding the request. Further, in certain contexts in literature, the term initiator may refer to a device (e.g., a particular master device) that initiates a request (as opposed to a master interface just forwarding a request initiated by another device), and the term target may refer to a device (e.g., a particular slave device) that processes a request (as opposed to a slave interface just forwarding a request processed by another device). In certain aspects, the term master device is used herein for a device acting in the capacity of an initiator, and not just a forwarding master interface, when the master device is initiating a transaction request. In certain aspects, the term slave device is used herein for a device acting in the capacity of a target, and not just a forwarding slave interface, when the slave device is processing a transaction request. The context should be clear to one of ordinary skill in the art based on the description herein.

An example of a master is a processor core. Examples of slaves include a slave processor, a display device (e.g., a graphics processor), a memory (e.g., a cache memory), a memory interface, a peripheral, a peripheral interface, a user input and/or output device, a user input, and/or output device interface (e.g., a Universal Serial Bus port). In some cases, the master devices may issue transaction requests to the slave devices, requesting the slave devices perform some sort of action (e.g., read data, write data, etc.). After executing the transaction requests the slave devices may transmit a response message to the master device that issued the transaction request. In certain cases, if the slave device receives too many transaction requests in a period of time, the slave device may become congested. Therefore, what is needed are techniques for alleviating congestion at the slave device while not significantly impacting overall system performance.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects, the present disclosure provides a method for operating a slave device. The method generally includes determining receiving a plurality of transaction requests from a master device for the slave device to execute and respond, determining whether a response criterion is met based on a number of the plurality of transaction requests that have been executed and a number of response messages transmitted to the master device for the plurality of transaction requests, while the response criterion is met, proceeding with transmitting response messages for the plurality of transaction requests, and while the response criterion is not met, refraining from transmitting response messages for any of the plurality of transaction requests.

In some aspects, the present disclosure provides an apparatus. The apparatus generally includes a master device configured to transmit a plurality of transaction requests. The apparatus also generally includes a slave device configured to receive the plurality of transaction requests from a master device for the slave device to execute and respond, determine whether a response criterion is met based on a number of the plurality of transaction requests that have been executed and a number of response messages transmitted to the master device for the plurality of transaction requests, while the response criterion is met, proceed with transmitting response messages for the plurality of transaction requests, and while the response criterion is not met, refrain from transmitting response messages for any of the plurality of transaction requests. Additionally, the apparatus also generally includes a socket interface coupling the master device with the slave device via which the plurality of transaction requests and response messages are transmitted.

In some aspects, the present disclosure provides a non-transitory computer-readable medium apparatus. The non-transitory computer-readable medium generally includes instructions that, when executed by at least one processor of a slave device, instructions that, when executed by at least one processor of a slave device, cause the at least one processor to: receive a plurality of transaction requests from a master device for the slave device to execute and respond, determine whether a response criterion is met based on a number of the plurality of transaction requests that have been executed and a number of response messages transmitted to the master device for the plurality of transaction requests, while the response criterion is met, proceed with transmitting response messages for the plurality of transaction requests, and while the response criterion is not met, refrain from transmitting response messages for any of the plurality of transaction requests.

In some aspects, the present disclosure provides an apparatus. The apparatus generally includes means for receiving a plurality of transaction requests from a master device for the slave device to execute and respond, determining whether a response criterion is met based on a number of the plurality of transaction requests that have been executed and a number of response messages transmitted to the master device for the plurality of transaction requests, while the response criterion is met, proceeding with transmitting response messages for the plurality of transaction requests, and while the response criterion is not met, refraining from transmitting response messages for any of the plurality of transaction requests.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 depicts a simplified diagram of a system bus architecture.

FIG. 2A illustrates the transmission of transaction requests and response messages between a master device and slave device.

FIG. 2B illustrates the transmission of a normal response message.

FIG. 2C illustrates the transmission of an early response message.

FIG. 3 illustrates example operations for operating a slave device, in accordance with certain aspects of the present disclosure.

FIG. 4 illustrates an example master/slave system employing a debt counter for controlling early response, in accordance with certain aspects presented herein.

FIG. 5 illustrates a computing that may include various components configured to perform operations for the techniques disclosed herein in accordance with aspects of the present disclosure.

### DETAILED DESCRIPTION

Aspects of the present disclosure provide apparatus, methods, processing systems, and computer readable mediums for controlling early responses in systems employing master devices and slave devices. For example, in such systems, master devices may issue or transmit transaction requests to the slave device, requesting the slave device perform some action, such as reading or writing data. Thereafter, the slave device may execute the transaction request and transmit a corresponding response message to the master device, acknowledging that the transaction request has been completed.

In some cases, the slave device may transmit a response message before execution of the corresponding transaction request, known as an early response. However, if the slave device transmits too many early responses, the slave device may become inundated with transaction requests from the master device leading to congestion at the slave device. One way to prevent such congestion may be for the slave device to not transmit early responses and instead transmit response messages only after a corresponding transaction request has been executed. However, this may result in response starvation at the master device and lead to the master device slowing down. Accordingly, aspects of the present disclosure provide techniques for controlling early responses in a slave device to help alleviate the issues of congestion at the slave device as well as response starvation at the master device.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. For example, though certain aspects are described with respect to a SoC, the aspects may similarly be applicable to any suitable computing device including a master device and a slave device.

Mobile computing device architectures have grown in complexity, and now commonly include multiple processor cores, system-on-chips (SoCs), co-processors, functional modules including dedicated processors (e.g., communication modem chips, GPS receivers, etc.), complex memory systems, intricate electrical interconnections (e.g., buses and/or fabrics), and numerous other resources that execute complex and power intensive software applications (e.g., video streaming applications, etc.).

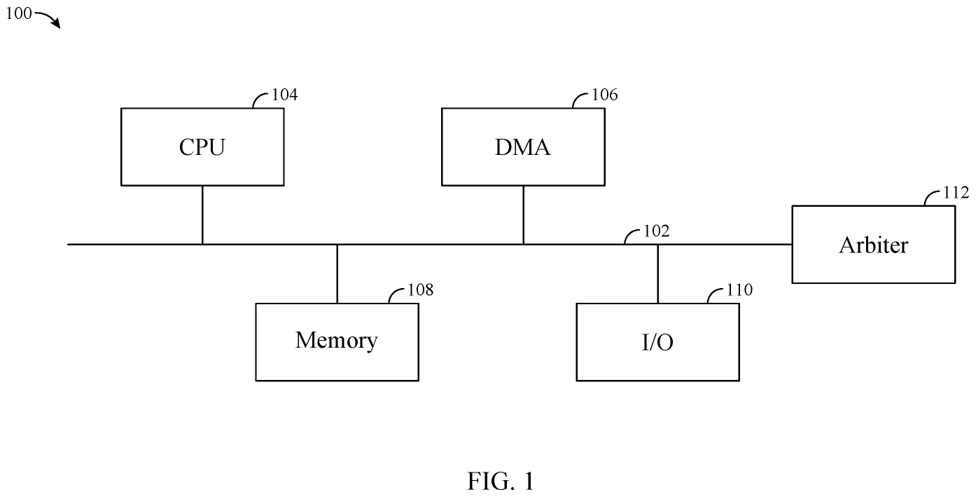

FIG. 1 depicts a simplified diagram of a system bus architecture 100. As illustrated, a system bus 102 may interconnect various system units. The system bus 102 may comprise address, data and control channels, and may perform bidirectional (e.g., read and write) data transfers. Master devices, such as the CPU 104 or a direct memory access (DMA) engine 106, may initiate transaction requests, such as data transfers, across one or more channels of the bus 102 to or from slave devices, such as memory 108 and input/output circuits 110. When two or more independent master devices 104, 106 are connected to the bus 102, access of the master devices 104, 106 to the system bus 102 may be controlled by an arbiter 112.

For example, in some cases, one or more of the master devices 104 or 106 may assert a bus request to the arbiter 112 to access the system bus 102. The arbiter 112 may monitor activity on the system bus 102, and when the system bus 102 becomes available, the arbiter 112 may send a bus grant to one of the requesting master devices 104 or 106. The granted master device 104 or 106 may then initiate transaction requests across one or more channels of the system bus 112, such as read or write cycles directed to one or more slave devices 108 or 110, as explained below.

In some cases, the system bus architecture 100 may be an example of a system-on-chip (SoC) infrastructure. SoCs are usually designed as memory-mapped systems in which functional intellectual property (IP) cores, such as the CPU 104 and DMA engine 106 may read and/or write bytes of data at certain addresses. Generally, the SoC infrastructure may handle these accesses, known as transaction requests, by routing them to the appropriate target, most often physical memory, such as memory 108.

The memory-mapped transaction requests may be carried, via the system bus 102, by an interface known as a socket, connecting a master device (e.g., which initiates the transaction and drives the address) and a slave device (e.g., which receives the transaction request and responds to it). A number of industry standard socket protocols exist, such as Advanced Microcontroller Bus Architecture (AMBA), an Advanced High-performance Bus (AHB), AMBA Advanced extensible Interface (AXI), Open Core Protocol (OCP), CoreConnect and other non-public protocols.

Most of these protocols may be known as split protocols in which transaction requests are split into a request phase (e.g., from master to slave) and a response phase (e.g., from slave to master). Multiple transactions may be overlapped (e.g., issued before receiving responses); however, each transaction starts with a request and ends with a response.

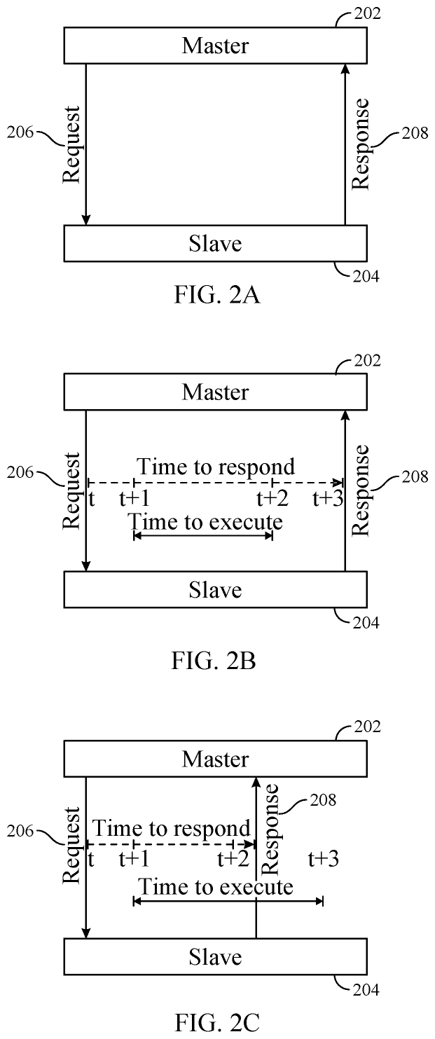

FIG. 2A illustrates an example transaction request and response scenario between a master device 202 and a slave device 204. The master device 202 and slave device 204 illustrated in FIG. 2A may be connected by a socket interface, as described above. In some cases, the master device 202 may comprise the CPU 104 and the slave device 204 may comprise the memory 108. As illustrated, the master device 202 may issue/transmit a transaction request 206 via the socket interface, which may be received by the slave device 204. At some later point in time, the slave device 204 may execute the transaction request 206 and may transmit a response message 208 to the master device 202 via the socket interface.

In some cases, the response message 208 may be transmitted before or after the slave device 204 has executed the transaction. The safest way to avoid congestion issues at the slave device 204 is for the slave device 204 to respond once all the actions resulting from the transaction request have been executed. The response message 208 is then the very last action taken by the slave device 204 with respect to the transaction request 206, which is known as a normal response. In certain circumstances, the slave device 204 may be able to transmit the response message 208 earlier while certain actions triggered by the transaction request 206 have not yet been executed. For instance, a memory controller of the slave device 204 may respond to a write request, pretending that the write request has been executed, while data associated with the write request have not yet been committed to memory. The memory controller must then ensure that any subsequent read will actually observe the updated memory. This is known as an early response.

FIG. 2B illustrates an example of a normal response message. As illustrated, at time t, the master device 202 may transmit a transaction request 206 to the slave device 204. After receiving the transaction request 206, the slave device may begin executing the transaction request 206 at some later point in time, such as t+1, and may finish executing the transaction request 206 at t+2. Thereafter, after finishing executing the transaction request 206, the slave device may transmit a response message 208 to the master device 202, responding to the transaction request 206. As noted above, waiting to transmit the response message 208 may be the safest way to avoid congestion at the slave device 202 since the master device may wait until the response message 208 is received to issue another transaction request, thereby avoiding a situation in which the slave device is inundated with transaction requests. However, in certain cases, having to wait to finish executing the transaction request to transmit a response message may lead to response starvation and slow down the master device. Thus, in certain cases, it may be beneficial to issue a response message to a transaction request before execution of that transaction request, known as an early response, as discussed above.

FIG. 2C illustrates an example of an early response message. As illustrated, at time t, the master device 202 may transmit a transaction request 206 to the slave device 204. After receiving the transaction request 206, the slave device may begin executing the transaction request 206 at some later point in time, such as t+1. Thereafter, at t+2, the slave device 204 may transmit the response message 208 to the master device 202, responding to the transaction request 206 (e.g., indicating that the transaction request 206 has been completed), before finishing executing the transaction request 206. The slave device 204 may then finish executing the transaction request 206 at t+3.

As noted, above, early responses are sometimes beneficial to IP cores/master devices that are latency sensitive as responding to transaction requests sooner speeds up these IP cores. However, early responses can sometimes be detrimental to the slave device. For example, in the case of normal responses, the master device may be aware of slave congestion as response messages are only transmitted once the transaction request has been executed. Thus, if response messages are continually delayed, the master device, having a limit on a number of pending transactions it can sustain, refrains from transmitting any new transaction requests until the number of pending transactions reduces, which correlates with the slave device no longer being congested.

However, when using early responses, the congestion of the slave device may not be apparent to the master device as the function of the early responses is to inform the master device that a transaction request has been completed before the transaction request has actually been completed. Accordingly, because the master device believes that the slave device is not congested, the master device may continue to issue transaction requests to the slave device, thereby compounding the congestion at the slave device and leading to an increase in an average response latency, creating head-of-link-blocking issues, and degrading a quality of service (QoS) at the mater device.

Accordingly, aspects of the present disclosure provide techniques for alleviating the issues of congestion of a slave device when providing early responses to transaction requests while also controlling response starvation of a master device. For example, in some cases, aspects of the present disclosure provide techniques for controlling when an early response to a transaction request may be transmitted. In some cases, such techniques may involve using a debt counter that may be maintained based on a number of a plurality of transaction requests that have been executed by a slave device and a number of response messages transmitted to a master device for the plurality of transaction requests.

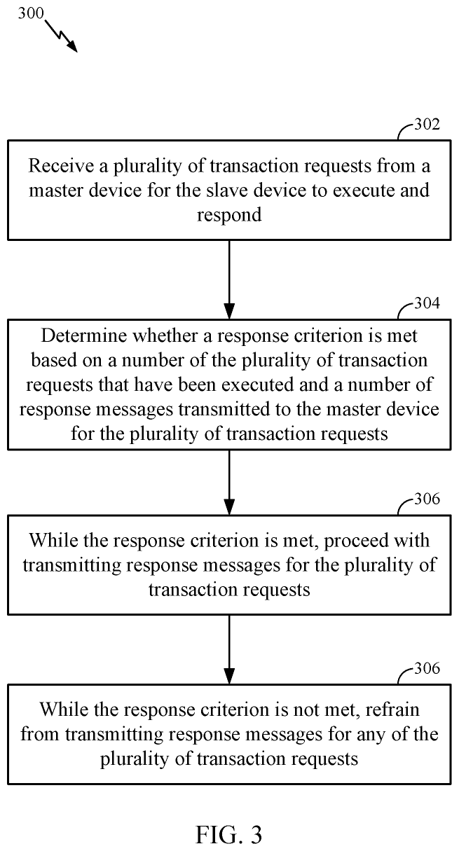

FIG. 3 illustrates example operations 300 for operating a slave device. Operations 300 may be performed by one or more components of a computing device, such as a memory controller of the memory 108 and/or an I/O controller of the I/O circuits 110.

Operations 300 begin at 302 by receiving a plurality of transaction requests from a master device for the slave device to execute and respond.

At 304, the slave device determining whether a response criterion is met based on a number of the plurality of transaction requests that have been executed and a number of response messages transmitted to the master device for the plurality of transaction requests.

At 306, the slave device proceeds, while the response criterion is met, with transmitting response messages for the plurality of transaction requests.

At 308, the slave device refrains, while the response criterion is not met, from transmitting response messages for any of the plurality of transaction requests.

As noted above, aspects of the present disclosure provide techniques for controlling when an early response to a transaction request may be transmitted. In some cases, such techniques may involve using a debt counter that may be maintained based on a number of a plurality of transaction requests that have been executed by a slave device and a number of response messages transmitted to a master device for the plurality of transaction requests.

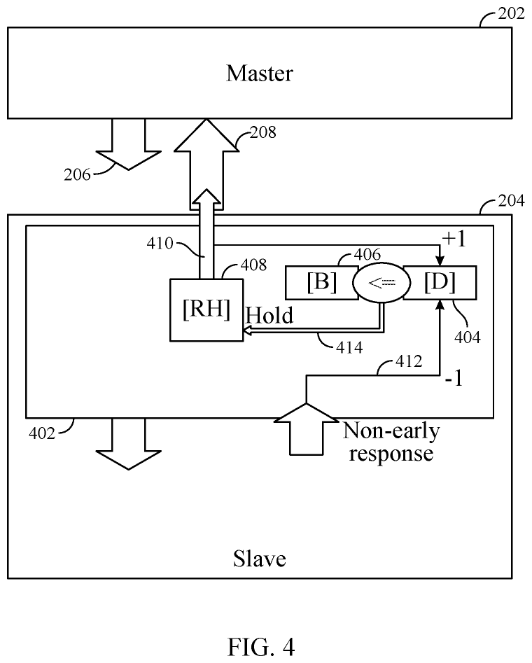

FIG. 4 illustrates an example master/slave system employing a debt counter for controlling early response, in accordance with certain aspects presented herein. For example, as illustrated, the slave device 204 may include a response manager 402 for controlling responses to the master device 202. The response manger 402 may include a debt counter 404, a bound configuration register 406, and a response holder 408.

According to aspects, the debt counter 404 may comprise a value that represents the difference between what the slave device 204 pretends to have done (e.g., with respect to the master device 202) and what the slave device 204 has actually done (e.g., internally). For example, as illustrated in FIG. 4, the debt counter 404 may be increased in response to transmitting a response message at 410 and may be decreased in response to executing a transaction request at 412. The bound configuration register 406 may include a configurable threshold value that controls whether a response to (any) transaction request may be transmitted to the master device 202. For example, as illustrated if the value of the debt counter 404 is greater than the threshold value of the bound configuration register 406, a hold signal 414 may be applied to the response holder 408 preventing any response message from being transmitted/issued by the slave device 204. However, if the value of the debt counter 404 is less than or equal to the threshold value of the bound configuration register 406 (e.g., due to the slave device executing a sufficient number of transaction requests), the slave device 204 may begin transmitting response messages, including early responses.

Aspects of the present disclosure will now go into more detail with respect to FIG. 4 regarding operations performed by the slave device 204 for determining whether to transmit response messages based, at least in part on the debt counter 404. For example, as noted above, the slave device 204 may receive a plurality of transaction requests 206 and may determine whether to transmit a response message 208 based on the plurality of transaction requests 206. For example, in some cases, the slave device 204 may determine whether a response criterion is met based on a number of the plurality of transaction requests that have been executed by the slave device 204 and a number of response messages 208 that have been transmitted by the slave device 204 to the master device 202 for the plurality of transaction requests 206.

According to aspects, based on the determination, the slave device 204 may proceed with transmitting response messages for the plurality of transaction requests 206 while the response criterion is met and may refrain from transmitting response messages for any of the plurality of transaction requests while the response criterion is not met.

In some cases, determining whether the response criterion is met based on a number of the plurality of transaction requests that have been executed by the slave device 204 and a number of response messages 208 that have been transmitted by the slave device 204 to the master device 202 for the plurality of transaction requests 206 may comprise maintaining a debt counter 404 equal to a difference between a measurement associated with response messages 208 transmitted to the master device 202 for the plurality of transaction requests 206 and a measurement associated with the plurality of transaction requests 206 that have been executed by the slave device 204.

In some cases, the measurement associated with the plurality of transaction requests that have been executed may include at least one of an amount of data (e.g., bytes, words, dynamic random access memory (DRAM) bursts, etc.) associated with the plurality of transaction requests that have been executed or a number of transaction requests of the plurality of transaction requests that have been executed. Similarly, in some cases, the measurement associated with the response messages transmitted to the master device for the plurality of transaction requests may comprise at least one of an amount of data (e.g., bytes, words, DRAM bursts, etc.) associated with the response messages transmitted to the master device or a number of response messages of the response messages transmitted to the master device for the plurality of transaction requests.

In some cases, the slave device 204 may determine whether the response criterion is met based on a threshold of the bound configuration register 406. For example, in some cases, when the debt counter 404 satisfies the threshold (e.g., based on the difference between the measurement associated with response messages transmitted to the master device for the plurality of transaction requests and the measurement associated with the plurality of transaction requests that have been executed), the slave device 204 may determine that the response criterion has been met. For example, in some cases, if a value of the debt counter 404 is below or equal to a value of the threshold of the bound configuration register 406, the slave device 204 may determine that the response criterion has been met. However, when the debt counter 404 does not satisfy the threshold, for example, due to the value of the debt counter 404 being greater than the threshold value, the slave device 204 may determine that the response criterion has not been met.

In some cases, the bound configuration register 406 may comprise a plurality of thresholds, each threshold corresponding to a different priority transaction request. For example, in some cases, different priorities may be associated with different types of transaction request. For example, some transaction requests may have high priority while other transaction requests may have a lower priority. Accordingly, in some cases, it may be beneficial to associate different thresholds with these different transaction request priority levels such that the slave device 204 may be allowed to transmit (early) responses corresponding to higher priority transaction requests while refraining from transmitting (early) responses corresponding to lower priority transaction requests. For example, in some cases, lower priority transaction requests may be associated with lower thresholds while higher priority transaction requests may be associated with higher thresholds, allowing the slave device 204 to transmit response messages for the higher priority transaction requests while at the same time refraining from transmitting response messages for the lower priority transaction requests.

Accordingly, in some cases, when determining whether the response criterion is met based on the number of the plurality of transaction requests that have been executed and the number of response messages transmitted to the master device for the plurality of transaction requests, the slave device 204 may compare the debt counter 404 to a plurality of thresholds, each of the plurality of thresholds associated with a different priority level. According to aspects, when the debt counter 404 satisfies a corresponding threshold of the plurality of thresholds associated with a corresponding priority level, the slave device 204 may determine that the response criterion is met for any of the plurality of transactions having at least the corresponding priority level and may proceed with transmitting response messages for any of the plurality of transactions having at least the corresponding priority level.

In other cases, when the slave device 404 determines that the debt counter 404 does not satisfy a corresponding threshold of the plurality of thresholds associated with a corresponding priority level, the slave device 404 may determine that the response criterion is not met for any of the plurality of transactions having less than the corresponding priority level. Accordingly, in response to the determination that the debt counter 404 does not satisfy the corresponding threshold of the plurality of threshold, the slave device may refrain from transmitting response messages for any of the plurality of transactions having less than the corresponding priority level.

Further, in some cases, when transmitting the response messages 208, the slave device 204 may make a determination (e.g., arbitrate) of which transaction requests 206 to respond to based on a priority associated with each of the transaction requests 206. Such determination of which response message to transmit may be important since the very act of transmitting the response message increases the debt counter 404 which may in turn force the slave device to refrain from transmitting response messages if the debt counter 404 does not satisfy the threshold of the bound configuration register 406.

Accordingly, the slave device 204 may select at least one transaction request of the plurality of transaction requests 206 for which to transmit a corresponding response message 208 based on a priority associated with the at least one transaction request of the plurality of transaction requests and may transmit the corresponding response message 208 for the selected at least one transaction request of the plurality of transaction requests 206. For example, as noted above, some transaction requests may be associated with higher priorities while other transaction requests may be associated with lower priorities. Accordingly, when presented with a scenario in which a response message 208 needs to be transmitted for a lower priority transaction request 206 as well as another response message 208 for a higher priority transaction requests 206, the slave device 204 may choose to transmit the response message 208 corresponding to the higher priority request 206 even if the lower priority transaction request 206 was received or executed before the higher priority transaction request 206. In other words, the slave device 204 may select the at least one transaction request independently of when the selected at least one transaction request was received or executed.

Additionally, in some cases, the slave device 204 may make a determination of which transaction request 206 to execute. For example, in some cases, in response to receiving the plurality of transaction requests 206, the slave device 204 may select a particular transaction request of the plurality of transaction requests to execute based, at least in part, on a priority associated with the particular transaction request and a type associated with the particular transaction request. The slave device may then execute the selected particular transaction request based on the priority associated with the particular transaction request and a type associated with the particular transaction request. For example, in addition to the higher and lower priorities of transaction requests described above, the type associated with the particular transaction request may, in some cases, include a type that requires execution of the particular transaction request before a corresponding response message can be transmitted. In other cases, the type associated with the particular transaction request may include a type that does not require execution of the particular transaction request before a corresponding response message can be transmitted.

For example, in some cases, if the type comprises the type that does not require execution of the particular transaction request before the corresponding response message can be transmitted, the slave device 204 may instead choose a different transaction request to execute since the slave device 204 may still be able to transmit the corresponding response message while being able to execute the transaction request at a later time.

In some cases, the debt counter 404 may be based on different pools of transaction requests. For example, in some cases, when receiving the plurality of transaction requests described above, the slave device 204 may place each transaction request into two different pools of transaction requests. For example, in some cases, the slave device 204 may place each received transaction request into a first pool of transaction requests to be executed and a second pool of transaction requests to be responded.

Thereafter, the slave device 404 may decide to execute a first transaction request in the first pool of transaction request to be executed. In some cases, the slave device 404 may decide to execute the first transaction request using the techniques described above with respect to execution priority. Once executed, the slave device 404 may remove the first transaction request from the first pool of transaction requests to be executed. For example, in some cases, the slave device 404 may decrease/decrement a value representing the number of transaction requests in the first pool.

Thereafter, at some later point in time, the slave device 404 may decide to transmit a response message for the first transaction request. In some cases, the slave device 404 may decide to transmit the response message for the first transaction request by using the techniques described above with respect to response message transmission priority. When the slave device 404 transmits a response message for the first transaction request, the salve device 404 may remove the first transaction request from the second pool of transaction requests to be responded.

As noted above, whether the slave device 404 transmits a response message may be based on whether the response criterion involving a debt counter have been satisfied. For example, in the case in which the slave device 404 maintains the two separate pools for transaction requests to be executed and transaction requests to be responded, the debt counter may keep track of, or represent, the difference (e.g., in any unit (i.e., number of transaction request, amount of data, etc.) between the amount of requests to be executed and the amount of requests to be responded. Accordingly, as noted above, when the debt counter satisfies the threshold of the bound configuration register 406, the response criterion is met and the slave device 404 may continue transmitting response messages, as described above.

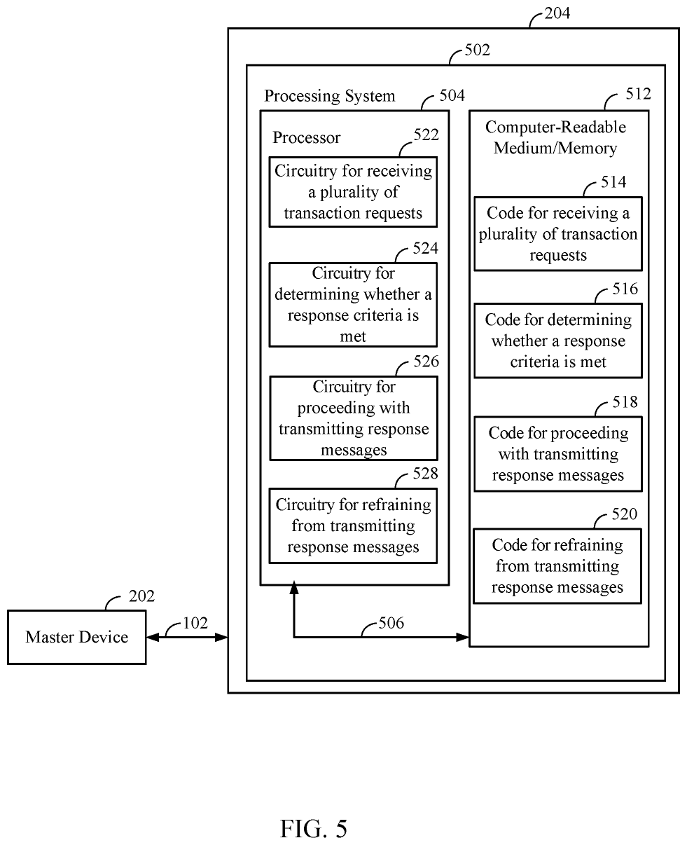

FIG. 5 is a block diagram conceptually illustrating a design of a computing device, such as the slave device 204, that may include various components (e.g., corresponding to means-plus-function components) configured to perform operations for the techniques disclosed herein, such as the operations illustrated in FIG. 3 as well as other operations disclosed herein for controlling early responses in systems employing master devices and slave devices. The slave device 204 includes a processing system 502 coupled to a master device 202 via a system bus 102 employing a socket interface. The master device 202 is configured to transmit a plurality of transaction requests, which may be received by the slave device 204. The processing system 502 may be configured to perform processing functions for the slave device 204, including processing signals received (e.g., transaction requests) and/or to be transmitted by the slave device 204 (e.g., response messages).

The processing system 502 includes a processor 504 coupled to a computer-readable medium/memory 512 via an internal bus 506. In certain aspects, the computer-readable medium/memory 512 is configured to store instructions (e.g., computer-executable code) that when executed by the processor 504, cause the processor 504 to perform the operations illustrated in FIG. 3 as well as other operations for performing the various techniques discussed herein for controlling early responses in systems employing master devices and slave devices. In certain aspects, computer-readable medium/memory 512 stores code 514 for receiving a plurality of transaction requests from a master device for the slave device to execute and respond; code 516 for determining whether a response criterion is met based on a number of the plurality of transaction requests that have been executed and a number of response messages transmitted to the master device for the plurality of transaction requests; code 518 for proceeding with transmitting response messages for the plurality of transaction requests while the response criterion is met; and code 520 for refraining from transmitting response messages for any of the plurality of transaction requests while the response criterion is not met.

In certain aspects, the processor 504 includes circuitry configured to implement the code stored in the computer-readable medium/memory 512. The processor 504 includes circuitry 522 for receiving a plurality of transaction requests from a master device for the slave device to execute and respond; circuitry 524 for determining whether a response criterion is met based on a number of the plurality of transaction requests that have been executed and a number of response messages transmitted to the master device for the plurality of transaction requests; circuitry 526 for proceeding with transmitting response messages for the plurality of transaction requests while the response criterion is met; and circuitry 528 for refraining from transmitting response messages for any of the plurality of transaction requests while the response criterion is not met.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 3.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for operating a slave device, comprising:
receiving a plurality of transaction requests from a master device for the slave device to execute and respond;
determining whether a response criterion is met based on a number of the plurality of transaction requests that have been executed and a number of response messages transmitted to the master device for the plurality of transaction requests;
while the response criterion is met, proceeding with transmitting response messages for the plurality of transaction requests; and
while the response criterion is not met, refraining from transmitting response messages for any of the plurality of transaction requests.

2. The method of claim 1, wherein, while the response criterion is met, a corresponding response message for a given transaction request can be transmitted prior to execution of the given transaction request.

3. The method of claim 1, wherein determining whether the response criterion is met based on the number of the plurality of transaction requests that have been executed and the number of response messages transmitted to the master device for the plurality of transaction requests comprises:
maintaining a debt counter equal to a difference between a measurement associated with response messages transmitted to the master device for the plurality of transaction requests and a measurement associated with the plurality of transaction requests that have been executed.

4. The method of claim 3, wherein:
the measurement associated with the plurality of transaction requests that have been executed comprises at least one of:
an amount of data associated with the plurality of transaction requests that have been executed; or
a number of transaction requests of the plurality of transaction requests that have been executed; and
the measurement associated with the response messages transmitted to the master device for the plurality of transaction requests comprises at least one of:
an amount of data associated with the response messages transmitted to the master device; or
a number of response messages of the response messages transmitted to the master device for the plurality of transaction requests.

5. The method of claim 3, further comprising determining whether the debt counter satisfies a threshold, wherein:
when the debt counter satisfies the threshold, the response criterion is met, and
when the debt counter does not satisfy the threshold, the response criterion is not met.

6. The method of claim 5, wherein:
the measurement associated with the plurality of transaction requests that have been executed comprises the number of transaction requests of the plurality of transaction requests that have been executed;
the measurement associated with the response messages transmitted to the master device for the plurality of transaction requests comprises the number of response messages of the response messages transmitted to the master device for the plurality of transaction requests;
the debt counter satisfies the threshold when the debt counter is less than or equal to the threshold; and
the difference is equal to the number of response messages transmitted to the master device for the plurality of transaction requests minus the number of the plurality of transaction requests that have been executed. The method of claim 5, wherein the threshold is adjustable.

8. The method of claim 3, wherein determining whether the response criterion is met based on the number of the plurality of transaction requests that have been executed and the number of response messages transmitted to the master device for the plurality of transaction requests comprises:
comparing the debt counter to a plurality of thresholds, each of the plurality of thresholds associated with a different priority level, wherein:
when the debt counter satisfies a corresponding threshold of the plurality of thresholds associated with a corresponding priority level, the response criterion is met for any of the plurality of transactions having at least the corresponding priority level, and transmitting response messages proceeds for any of the plurality of transactions having at least the corresponding priority level; and
when the debt counter does not satisfy a corresponding threshold of the plurality of thresholds associated with a corresponding priority level, the response criterion is not met for any of the plurality of transactions having less than the corresponding priority level, and response messages are refrained from being transmitted for any of the plurality of transactions having less than the corresponding priority level.

9. The method of claim 1, wherein proceeding with transmitting response messages for the plurality of transaction requests comprises:
selecting at least one transaction request of the plurality of transaction requests for which to transmit a corresponding response message based on a priority associated with the at least one transaction request of the plurality of transaction requests; and
transmitting the corresponding response message for the selected at least one transaction request of the plurality of transaction requests.

10. The method of claim 9, wherein selecting the at least one transaction request is independent of when the selected at least one transaction request was received.

11. The method of claim 10, further comprising:
selecting a particular transaction request of the plurality of transaction requests to execute based, at least in part, on a priority associated with the particular transaction request and a type associated with the particular transaction request; and
executing the selected particular transaction request based on the priority associated with the particular transaction request and a type associated with the particular transaction request.

12. The method of claim 11, wherein:
the priority associated with the particular transaction request is based on whether the particular transaction not being executed is preventing transmission of response messages; and
the type associated with the particular transaction request comprises one of:
a type that requires execution of the particular transaction request before a corresponding response message can be transmitted; or
a type that does not require execution of the particular transaction request before a corresponding response message can be transmitted.

13. An apparatus, comprising:
a master device configured to transmit a plurality of transaction requests;
a slave device configured to:
receive the plurality of transaction requests from a master device for the slave device to execute and respond;
determine whether a response criterion is met based on a number of the plurality of transaction requests that have been executed and a number of response messages transmitted to the master device for the plurality of transaction requests;
while the response criterion is met, proceed with transmitting response messages for the plurality of transaction requests; and
while the response criterion is not met, refrain from transmitting response messages for any of the plurality of transaction requests; and
a socket interface coupling the master device with the slave device via which the plurality of transaction requests and response messages are transmitted.

14. The apparatus of claim 13, wherein, while the response criterion is met, a corresponding response message for a given transaction request can be transmitted prior to execution of the given transaction request.

15. The apparatus of claim 13, wherein, in order to determine whether the response criterion is met based on the number of the plurality of transaction requests that have been executed and the number of response messages transmitted to the master device for the plurality of transaction requests, the slave device is further configured to:
maintain a debt counter equal to a difference between a measurement associated with response messages transmitted to the master device for the plurality of transaction requests and a measurement associated with the plurality of transaction requests that have been executed.

16. The apparatus of claim 15, wherein:
the measurement associated with the plurality of transaction requests that have been executed comprises at least one of:
an amount of data associated with the plurality of transaction requests that have been executed; or
a number of transaction requests of the plurality of transaction requests that have been executed; and
the measurement associated with the response messages transmitted to the master device for the plurality of transaction requests comprises at least one of:
an amount of data associated with the response messages transmitted to the master device; or
a number of response messages of the response messages transmitted to the master device for the plurality of transaction requests.

17. The apparatus of claim 15, wherein the slave device is further configured to determine whether the debt counter satisfies a threshold, wherein:
when the debt counter satisfies the threshold, the response criterion is met, and
when the debt counter does not satisfy the threshold, the response criterion is not met.

18. The apparatus of claim 17, wherein:
the measurement associated with the plurality of transaction requests that have been executed comprises the number of transaction requests of the plurality of transaction requests that have been executed;
the measurement associated with the response messages transmitted to the master device for the plurality of transaction requests comprises the number of response messages of the response messages transmitted to the master device for the plurality of transaction requests;
the debt counter satisfies the threshold when the debt counter is less than or equal to the threshold; and
the difference is equal to the number of response messages transmitted to the master device for the plurality of transaction requests minus the number of the plurality of transaction requests that have been executed.

19. The apparatus of claim 15, wherein, in order to determine whether the response criterion is met based on the number of the plurality of transaction requests that have been executed and the number of response messages transmitted to the master device for the plurality of transaction requests, the slave device is further configured to:
compare the debt counter to a plurality of thresholds, each of the plurality of thresholds associated with a different priority level, wherein:
when the debt counter satisfies a corresponding threshold of the plurality of thresholds associated with a corresponding priority level, the response criterion is met for any of the plurality of transactions having at least the corresponding priority level, and transmitting response messages proceeds for any of the plurality of transactions having at least the corresponding priority level; and
when the debt counter does not satisfy a corresponding threshold of the plurality of thresholds associated with a corresponding priority level, the response criterion is not met for any of the plurality of transactions having less than the corresponding priority level, and response messages are refrained from being transmitted for any of the plurality of transactions having less than the corresponding priority level.

20. A non-transitory computer readable medium, comprising:
instructions that, when executed by at least one processor of a slave device, cause the at least one processor to:
receive a plurality of transaction requests from a master device for the slave device to execute and respond;
determine whether a response criterion is met based on a number of the plurality of transaction requests that have been executed and a number of response messages transmitted to the master device for the plurality of transaction requests;
while the response criterion is met, proceed with transmitting response messages for the plurality of transaction requests; and
while the response criterion is not met, refrain from transmitting response messages for any of the plurality of transaction requests.
